(19) United States
(12) Patent Application Publication
(10) Pub. No.: US 2010/0046117 A1
(43) Pub. Date: Feb. 25, 2010

(54) MAGNETIC RECORDING MEDIUM AND METHOD OF PRODUCING THE SAME

(75) Inventors: Naoto ABE, Odawara-shi (JP); Toshiyuki KITAHARA, Odawara-shi (JP); Takeshi HARASAWA, Odawara-shi (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/543,097

(22) Filed: Aug. 18, 2009

(30) Foreign Application Priority Data
Aug. 19, 2008 (JP) 2008-210725

(51) Int. Cl. G11B 5/78; B05D 5/12

(52) U.S. Cl. 360/134; 427/130; G9B/5.291

(57) ABSTRACT

A magnetic recording medium includes a nonmagnetic support and a magnetic layer, and has a coefficient of dynamic friction, on the magnetic layer side surface, of 0.5 or larger as measured at a speed of 1 m/s relative to a sliding member of a magnetic head.

### CROSS-REFERENCE TO RELATED APPLICATIONS

This application claims the benefit of Japanese Patent Application JP 2008-210725, filed Aug. 19, 2008, the entire content of which is hereby incorporated by reference, the same as if set forth at length.

### FIELD OF THE INVENTION

This invention relates to a magnetic recording medium particularly suited to high density magnetic recording and a method of producing the same.

### BACKGROUND OF THE INVENTION

Magnetic recording media, including magnetic tapes and magnetic disks, are used in broad applications, such as information recording media of electronic equipment for business and home use and backup tapes for data storage. Because of the popularity of broadband network and digital TV broadcast, the volume of data to be processed has been drastically increasing, and the demands for data-storage devices with larger capacities have been increasing accordingly. This tendency has also boosted the demand for magnetic recording media achieving higher density recording.

Various techniques for high density recording have been proposed and put to practical use. For example, introduction of an MR read head and a PRML signal processing method has now come to be requisite techniques. Introduction of these techniques has brought marked advancement in high density recording with magnetic recording media. From the aspect of recording media, various improvements coping with the advancement have been attempted, such as smoothing and uniform thickness reduction of a magnetic layer, improving magnetic characteristics of a ferromagnetic substance, size reduction of ferromagnetic particles, and increase in packing density of ferromagnetic particles.

Smoothing and uniform thickness reduction of a magnetic layer should be achieved without damaging the running properties of a magnetic recording medium from the tribological aspect. That is, a smoother surface of a magnetic layer is less causative of a spacing loss and enables higher density recording but produces a larger frictional force with a sliding member of a magnetic head. An increased frictional force leads to problems in running properties and tribology, such as the problem of adhesion to a sliding member. Therefore, the conventional techniques for high density recording have been achieved while reducing the dynamic friction coefficient (see, e.g., JP 11-39643A and JP 2006-131874A).

### SUMMARY OF THE INVENTION

As stated, the conventional techniques are to encounter with difficulty in further increasing recording density because an attempt to further smoothen the surface of a magnetic recording medium results in an increase of frictional force.

An object of the invention is to provide a magnetic recording medium that is able to achieve an increased recording density while retaining good running properties.

The inventors of the present invention have found that a magnetic recording medium having a much larger coefficient of dynamic friction with a magnetic head than in the prior art achieves good balance between running properties and electromagnetic characteristics because the film of air entrapped between the head and the recording medium is thin and stable to make a spacing variation smaller. Based on this finding, the object of the invention is accomplished by the provision of a magnetic recording medium including a nonmagnetic support and a magnetic layer, the magnetic recording medium having a coefficient of dynamic friction, on its magnetic layer side surface, of 0.5 or larger as measured at a running speed of 1 m/s relative to a sliding member of a magnetic head.

The invention also provides preferred embodiments of the magnetic recording medium, in which (1) the magnetic layer side surface has an arithmetic average roughness Ra of 0.2 to 1.0 nm; (2) the magnetic layer contains no fatty acid as a lubricant; (3) the magnetic layer contains a fatty acid ester as a sole lubricant; or (4) the magnetic recording medium is a magnetic tape.

The invention also provides a method of producing the magnetic recording medium of the invention. The method includes the steps of applying a coating composition for a magnetic layer to a nonmagnetic support to form a magnetic layer and subjecting the magnetic layer to polishing and smoothing.

In a preferred embodiment of the method, the polishing is lapping.

According to the invention, since the air gap (flying height) between a magnetic head and the magnetic recording medium is maintained small and stable with no vertical motion, the magnetic recording medium exhibits excellent running properties as well as good electromagnetic characteristics. The magnetic recording medium of the invention is allowed to have an increased coefficient of dynamic friction over comparative prior art and is therefore designable to enable still higher density recording. The magnetic recording medium of the invention in tape form exhibits good wind quality to provide a satisfactory tape pack.

### DETAILED DESCRIPTION OF THE INVENTION

The magnetic recording medium of the invention is not limited in layer structure as long as it includes a nonmagnetic support and a magnetic layer on at least one side of the support. A preferred layer structure includes a nonmagnetic support, a magnetic layer on one side of the support, and a backcoat on the other side of the support (opposite to the magnetic layer) A nonmagnetic layer may be provided on the magnetic layer.

The magnetic recording medium has a coefficient of dynamic friction, on its magnetic layer side surface, of 0.5 or larger as measured at a speed of 1 m/s relative to a sliding member of a magnetic head. The sliding member of a magnetic head is exemplified by an AlTiC slider of an MR head. An AlTiC slider of an MR head usually has an arithmetic average roughness Ra of about 0.5 to 6.0 nm, preferably 0.5 to 2.0 nm. The dynamic friction coefficient as referred to herein is a value measured at 23° C. and 50% RH. The dynamic friction coefficient is preferably 0.5 to 0.9, even more preferably 0.6 to 0.8.

A magnetic tape speed in writing and reading is 3 m/s or higher. At such a high running speed, an air film is created between a magnetic head and a magnetic tape. When a magnetic tape has a dynamic friction coefficient of 0.5 or higher, the air film at a writing and reading speed (i.e., 3 m/s or higher) is kept stably thin. This means that the spacing per se between a magnetic head and a magnetic tape and also a spacing variation are reduced to increase the reproduction output and to decrease an output variation. This is considered to account for the improved electromagnetic characteristics obtained by the invention compared with the magnetic recording media whose dynamic friction coefficient is out of the range recited.

Since the air film is formed in a stable manner, the high frictional coefficient as recited does not influence the friction with, or wear of, a magnetic head nor cause lateral tape motion (LTM) during tape running. The high frictional coefficient at a low speed secures good wind quality to provide a good tape pack on a reel. A good tape pack contributes to stable running properties.

Thus, the magnetic recording medium of the invention is of revolutionary design that makes it possible to satisfy both the requirements for running properties and electromagnetic characteristics.

Intensive experimentation has revealed that a magnetic recording medium having a dynamic friction coefficient of 0.5 or larger at a speed of 1 m/s achieves both excellent running properties and electromagnetic characteristics. The speed for the friction measurement, 1 m/s, is believed to be approximately at the boundary between air film formation and contact between the medium and a head. When the measurement is taken at a speed of 2 m/s, closer to the tape speed during writing/reading, air is certainly entrapped between a medium and a head to exert a predominant influence of fluid lubrication, tending to make the dynamic friction coefficient stationary at 0.5 or less. Such being the case, the influence of the difference in dynamic friction coefficient is hard to appreciate, resulting in a failure to show an effective range of the dynamic friction coefficient to achieve the object of the invention. When the measurement is conducted at a speed lower than 1 m/s at which air is not entrapped allowing a head to contact the medium, the dynamic friction coefficient increases. However, the object of the invention is not accomplished with a magnetic recording medium that has a dynamic friction coefficient of 0.5 or larger at, for example, 0.5 m/s but reduces the coefficient to less than 0.5 at 1 m/s as a result of air film formation. Accordingly, the inventors have ascertained the importance of a dynamic friction coefficient of 0.5 or higher at a speed of 1 m/s and thus specified the range.

In this art, frictions occurring between a magnetic recording medium and a magnetic head, between a magnetic tape and a tape guide, and the like are of concern. It has been believed that, with a dynamic friction coefficient of 0.5 or higher, a magnetic head suffers from problems, such as wear, contamination with debris from a recording medium, seizure, and tracking error and, at the tape guide, the lateral tape motion (LTM) problem occurs to cause tracking error and tape edge damage. For these reasons, a magnetic recording medium has generally been designed to have a dynamic friction coefficient of 0.2 or lower. Hence, the dynamic friction coefficient of 0.5 or higher at a speed of 1 m/s is unthinkably large in terms of technological knowledge.

According to JP 11-39643A and JP 2006-131874A cited supra, each of the concrete figures given as a dynamic friction coefficient of a magnetic recording medium is about 0.2 to 0.3 as measured at a far lower speed (i.e., 5 mm/s or 18 mm/s) than the speed used in the invention. If measured at the speed employed in the invention, the coefficient in JP 11-39643A and JP 2006-131874A would be still smaller.

JP 7-73450A states that the coefficient of dynamic friction in Comparative Example 2 was 0.54, in which the measurement was taken at a speed of 10.05 mm/s. In this case, too, this value would reduce to less than 0.5 if measured at the speed specified in the present invention.

A magnetic recording medium can be designed to have a dynamic friction coefficient adjusted as specified by appropriately controlling the conditions of hereinafter described polishing and smoothing treatments given to a magnetic layer formed by applying a magnetic coating composition. More specifically, the dynamic friction coefficient may be adjusted as specified by controlling lapping pressure or speed in dry or wet lapping or calender roll temperature and speed of a calender in smoothing as described infra.

The dynamic friction coefficient may also be adjusted by the selection of a lubricant to be incorporated into the magnetic layer. More specifically, using a fatty acid ester compound alone is preferred to using a mixture of a fatty acid (e.g., stearic acid) and a fatty acid ester compound in order to increase the dynamic friction coefficient.

The surface of the magnetic layer preferably has an arithmetic average roughness Ra (hereinafter simply referred to as Ra) of 0.2 to 1.0 nm. With an Ra of 1.0 nm or smaller, air film formation between the tape and a magnetic head at the tape speed during writing/reading is stabilized to make the spacing and the spacing variation smaller. With an Ra of 0.2 nm or larger, the magnetic recording layer is prevented from sticking or being destroyed in measuring dynamic friction coefficient at a speed of 1 m/s due to too much surface smoothness. The Ra of the magnetic layer surface is more preferably 0.2 to 0.8 nm, even more preferably 0.2 to 0.5 nm. As used herein, the term “arithmetic average roughness Ra” or simply “Ra” denotes the Ra specified in JIS B0601-1994 (Terms, definitions and surface texture parameters).

The Ra of the magnetic layer is adjusted as desired by appropriately selecting or controlling the surface roughness of the nonmagnetic support, the particle size and amount of powder used in the magnetic layer, the above described conditions of lapping (in either dry or wet process), the surface profile, temperature, and rotational speed of calender rolls, and the like within the respective ranges described later.

The elements making up the magnetic recording medium of the invention will then be described.

### 1. Nonmagnetic Support

The nonmagnetic support that can be used in the invention can be of any known materials, such as polyesters, e.g., polyethylene terephthalate (PET) and polyethylene naphthalate (PEN); polyolefins, cellulose triacetate, polycarbonate, polyamide, polyimide, polyamide-imide, polysulfone, aromatic polyamide, and polybenzoxazole. PET or PEN film is preferred. The nonmagnetic support may previously be subjected to a surface treatment, such as a corona discharge treatment, a plasma treatment, an adhesion enhancing treatment, and a heat treatment.

The nonmagnetic support has a Young's modulus of at least 7 GPa, preferably 7.5 to 11 GPa, more preferably 7.6 to 10.8 GPa, in both longitudinal and lateral directions. The Young's modulus in the longitudinal direction and that in the lateral direction may be the same or different. The Young's modulus of the support may be adjusted by biaxially stretching an unstretched film to orient the polymer molecules in two directions either simultaneously or successively. The stretching conditions, such as temperature and rate, are decided in a known manner.

The nonmagnetic support preferably has, on the side on which a magnetic layer is to be provided, a centerline average surface roughness Ra of 0.5 to 4.0 nm, preferably 0.5 to 2.0 nm, measured with an optical profiler (HD-2000 from WYKO). The surface roughness on one side of the support and that on the other side may be the same or different. The surface profile of the support is controllable by the choice of the size and quantity of filler particles added.

The support usually has a thickness of about 3 to 60 μm, preferably 3 to 40 μm. The support for use in a magnetic tape is usually about 3.0 to 6.5 μm, preferably 3.5 to 4.0 μm.

### 2. Magnetic Layer

The magnetic layer contains ferromagnetic powder. Ferromagnetic powder that can be used in the invention includes ferromagnetic metal powder and ferromagnetic hexagonal ferrite powder.

The ferromagnetic metal powder is not limited, provided that Fe is a main component. Ferromagnetic alloys mainly comprising α-Fe are preferred. The ferromagnetic metal powder may further contain, in addition to Fe, Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, and so forth. Ferromagnetic alloys containing at least one of Al, Si, Ca, Y, Ba, La, Nd, Co, Ni, and B in addition to α-Fe are still preferred. Those containing Co, Al, and Y are particularly preferred. Those containing 10 to 40 atom % of Co, 2 to 20 atom % of Al, and 1 to 15 atom % of Y each based on Fe are especially preferred. The ferromagnetic metal powder may contain a small amount of a hydroxide or an oxide. The water content of the ferromagnetic metal powder, which is preferably optimized according to the kind of the binder to be combined with, preferably ranges from 0.01% to 2% by mass.

The ferromagnetic metal powder preferably has an average length (long axis length) of 20 to 100 nm, still preferably 30 to 90 nm, even still preferably 40 to 80 nm. With an average length of 20 nm or longer, reduction of magnetic characteristics due to the thermal fluctuation is effectively reduced. With an average length of 100 nm or shorter, a good S/N is obtained while retaining low noise. The average length is calculated from values obtained by directly reading the length and breadth of ferromagnetic metal particles on a transmission electron micrograph and values obtained by tracing the image of particles of the micrograph using an image analyzer IBASSI, from Carl Zeiss, Inc.

The ferromagnetic metal powder preferably has a crystallite size of 8 to 20 nm, still preferably 10 to 18 nm, even still preferably 12 to 16 nm. The crystallite size is an average calculated from a half value width of the X-ray diffraction peak by Scherrer's formula. X-Ray diffractometry is carried out using RINT 2000 from Rigaku Co., Ltd. equipped with a CuKα1 ray source at a tube voltage of 50 kV and a tube current of 300 mA.

The ferromagnetic metal powder preferably has a BET specific surface area (S_{BET}) of 30 to 50 m²/g, still preferably 38 to 48 m²/g, so as to secure satisfactory surface properties and low noise.

The ferromagnetic metal powder preferably has a coercive force Hc of 159.2 to 238.8 kA/m, still preferably 167.2 to 230.8 kA/m, a saturation magnetic flux density of 150 to 300 mT, still preferably 160 to 290 mT, and a saturation magnetization σs of 140 to 170 A·m²/kg, still preferably 145 to 160 A·m²/kg.

The ferromagnetic metal powder is preferably acicular particles. Acicular ferromagnetic metal particles preferably have an average aspect ratio (arithmetic average of length/breadth) of 4 to 12, still preferably 5 to 12.

The ferromagnetic metal powder can be prepared by known processes, including reduction of hydrated iron oxide or iron oxide with a reducing gas (e.g., hydrogen) into Fe or Fe—Co particles; reduction of a composite organic acid complex salt (mainly an oxalate) with a reducing gas (e.g., hydrogen); pyrolysis of a metal carbonyl compound; reduction of a ferromagnetic metal by adding a reducing agent (e.g., sodium borohydride, a hypophosphite, or hydrazine) to an aqueous solution of the ferromagnetic metal; and vaporization of a metal in a low-pressure inert gas. The resulting ferromagnetic metal powder may be subjected to a slow oxidation treatment. For example, ferromagnetic metal powder obtained by reducing hydrated iron oxide or iron oxide with a reducing gas, such as hydrogen, is treated in an atmosphere having a controlled oxygen to inert gas ratio at a controlled temperature for a controlled time to form an oxide film on its surface. This slow oxidation technique is preferred for reduced involvement of demagnetization.

Hexagonal ferrite powder, which can be used in the invention as ferromagnetic powder, has a hexagonal magnetoplumbite structure with very high uniaxial magnetic anisotropy and very high coercive force (Hc). Using hexagonal ferrite powder provides magnetic recording media superior in chemical stability, corrosion resistance, and wear resistance and allows for reduction of spacing loss, reduction of magnetic layer thickness, high C/N, and high resolution. Therefore, hexagonal ferrite powder is preferred to ferromagnetic metal powder to achieve high density recording.

Examples of the hexagonal ferrite powder that can be used in the invention include barium ferrite, strontium ferrite, lead ferrite, calcium ferrite, and cobalt ferrite. Specific examples are barium ferrite and strontium ferrite of magnetoplumbite type; magnetoplumbite type ferrites coated with spinel; and barium ferrite and strontium ferrite of magnetoplumbite type containing a spinel phase in parts. These ferrites may contain additional elements, such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, and Zr. For example, ferrites doped with Co—Ti, Co—Ti—Zr, Co—Ti—Zn, Ni—Ti—Zn, Nb—Zn—Co, Sb—Zn—Co, Nb—Zn, etc. can be used preferably. Depending on the raw materials or the processes adopted, some ferrites may contain intrinsic impurity.

The ferromagnetic hexagonal ferrite powder preferably has an average length of 5 to 40 nm, still preferably 10 to 38 nm, even still preferably 15 to 36 nm. The average length is calculated from values obtained by directly reading the length of ferromagnetic metal particles on a transmission electron micrograph and values obtained by tracing the image of particles of the micrograph using an image analyzer IBASSI, from Carl Zeiss, Inc.

The average aspect ratio (length to thickness ratio) of the ferromagnetic hexagonal particles is desirably 1 to 15, more desirably 2 to 7. With the average aspect ratio being 1 to 15, sufficient orientation can be obtained while reducing the noise due to particles' stacking. The particles within the above-recited size ranges preferably have a BET specific surface area (S_{BET}) of 10 to 200 m²/g. The specific surface area approximately agrees with the value arithmetically calculated from the length and the thickness of the particles.

The ferromagnetic hexagonal ferrite preferably has a crystallite size of 50 to 450 Å, still preferably 100 to 350 Å.

It is usually preferred for the hexagonal ferrite powder to have as narrow a particle size (length and thickness) distribution as possible. Although it is difficult to quantify the length and thickness of platy particles, comparison can be made among, e.g., 500 particles randomly chosen from a transmission electron micrograph. While the size distribution is mostly not normal, the coefficient of variation represented by the standard deviation σ divided by the mean (σ/mean) is preferably 0.1 to 2.0. In order to make the particle size distribution sharper, the reaction system for particle formation is made uniform as much as possible, and the particles produced are subjected to treatment for distribution improvement. For example, selective dissolution of ultrafine particles in an acid solution is among known treatments.

The coercive force Hc of the hexagonal ferrite powder used in the invention is preferably 159.2 to 238.8 kA/m, still preferably 175.1 to 222.9 kA/m, even still preferably 183.1 to 214.9 kA/m, provided that, when a write head has a saturation magnetization of 1.4 T or less, it is preferred for the hexagonal ferrite powder to have an Hc of 159.2 kA/m or less. The coercive force Hc can be controlled by the particle size (length and thickness), the kinds and amounts of constituent elements, the substitution site of elements, conditions of particle forming reaction, and the like.

The hexagonal ferrite powder preferably has a saturation magnetization σs of 40 to 80 A·m²/kg. A relatively high σs within that range is desirable. A saturation magnetization tends to decrease as the particle size becomes smaller. It is well known that the saturation magnetization can be improved by using a magnetoplumbite type ferrite combined with a spinel type ferrite or by properly selecting the kinds and amounts of constituent elements. It is also possible to use a W-type hexagonal ferrite powder.

The hexagonal ferrite powder for use in the invention can be prepared by, for example, (1) a process by controlled crystallization of glass which includes the steps of blending barium oxide, iron oxide, an oxide of a metal that is to substitute iron, and a glass forming oxide (e.g., boron oxide) in a ratio providing a desired ferrite composition, melting the blend, rapidly cooling the melt into an amorphous solid, re-heating the solid, washing and grinding the solid to obtain a barium ferrite crystal powder, (2) a hydrothermal process which includes the steps of neutralizing a solution of barium ferrite-forming metal salts with an alkali, removing by-products, heating in a liquid phase at 100° C. or higher, washing, drying, and grinding to obtain a barium ferrite crystal powder, and (iii) a coprecipitation process which includes the steps of neutralizing a solution of barium ferrite-forming metal salts with an alkali, removing by-products, drying, treating at 1100° C. or lower, and grinding to obtain a barium ferrite crystal powder. Although it is essentially desirable for the ferromagnetic hexagonal ferrite powder to be free from inorganic soluble ions, such as Na, Ca, Fe, Ni, and Sr ions, presence of up to 200 ppm of such ions is little influential on the characteristics.

The magnetic layer usually contains a binder. Binders used in the present invention include known thermoplastic resins, thermosetting resins, reactive resins, and mixtures thereof. Examples of useful thermoplastic resins include homo- or copolymers containing a unit derived from vinyl chloride, vinyl acetate, vinyl alcohol, maleic acid, acrylic acid, an acrylic ester, vinylidene chloride, acrylonitrile, methacrylic acid, a methacrylic ester, styrene, butadiene, ethylene, vinyl butyral, vinyl acetal or a vinyl ether; polyurethane resins, and various types of rubber resins. Examples of useful thermosetting or reactive resins include phenolic resins, epoxy resins, thermosetting polyurethane resins, urea resins, melamine resins, alkyd resins, reactive acrylic resins, formaldehyde resins, silicone resins, epoxy-polyamide resins, polyester resin/isocyanate prepolymer mixtures, polyester polyol/polyisocyanate mixtures, and polyurethane/polyisocyanate mixtures. For the details of these binder resins, Plastic Handbook published by Asakura Shoten can be referred to.

Known electron beam curing resins are also useful as a binder. Examples of, and process of producing, such electron beam curing resins are described in JP 62-256219A.

Preferred of the binder resins described are polyurethane resins. The polyurethane resin may have known structures, such as polyester polyurethane, polyether polyurethane, polyether polyester polyurethane, polycarbonate polyurethane, polyester polycarbonate polyurethane, and polycaprolactone polyurethane. In order to ensure dispersing capabilities for powders and durability of the magnetic recording medium according to necessity, it is preferred to introduce into the polyurethane resins at least one polar group by copolymerization or through addition reaction, the polar group being selected from —COOM, —SO₃M, —OSO₃M, —P═O(OM)₂, —O—P═O(OM)₂ (wherein M is a hydrogen atom or an alkali metal), —OH, —NR₂, —N⁺R₃ (wherein R is a hydrocarbon group), an epoxy group, —SH, —CN, and so on. The amount of the polar group to be introduced is preferably 10⁻¹ to 10⁻⁸ mol/g, still preferably 10⁻² to 10⁻⁶ mol/g.

The polyurethane resin preferably has a glass transition temperature of −50° to 150° C., still preferably 0° to 100° C.; an elongation at break of 100% to 2000%; a stress at rupture of 0.49 to 98 Mpa; and a yield point of 0.49 to 98 Mpa.

Examples of commercially available binder resins useful in the invention are VAGH, VYHH, VMCH, VAGF, VAGD, VROH, VYES, VYNC, VMCC, XYHL, XYSG, PKHH, PKHJ, PKHC, and PKFE (from Union Carbide Corp.); MPR-TA, MPR-TA5, MPR-TAL, MPR-TSN, MPR-TMF, MPR-TS, MPR-TM, and MPR-TAO (from Nisshin Chemical Industry Co., Ltd.); 1000W, DX80, DX81, DX82, DX83, and 100FD (from Denki Kagaku Kogyo K.K.); MR-104, MR-105, MR110, MR100, MR555, and 400X-110A (from Zeon Corp.); Nipporan N2301, N2302, and N2304 (from Nippon Polyurethane Industry Co., Ltd.) ; Pandex T-5105, T-R3080, and T-5201, Barnock D-400 and D-210-80, and Crisvon 6109 and 7209 (from Dainippon Ink & Chemicals, Inc.); Vylon UR8200, UR8300, UR-8700, RV530, and RV280 (from Toyobo Co., Ltd.); Daiferamin 4020, 5020, 5100, 5300, 9020, 9022, and 7020 (from Dainichiseika Color & Chemicals Mfg. Co., Ltd.); MX5004 (from Mitsubishi Chemical Corp.); Sanprene SP-150 (from Sanyo Chemical Industries, Ltd.); and Saran F310 and F210 (from Asahi Chemical Industry Co., Ltd.).

The amount of the binder in the magnetic layer is preferably 5% to 50% by mass, still preferably 10% to 30% by mass, based on the ferromagnetic powder. In using a polyurethane resin, it is preferably used in an amount of 2% to 20% by mass.

Where needed, the magnetic layer can contain additives, such as dispersants, lubricants, surfactants, abrasives, antifungals, antistatics, antioxidants, solvents, and carbon black.

Examples of suitable dispersant include phenylphosphonic acid, α-naphthylphosphoric acid, phenylphosphoric acid, diphenylphosphoric acid, p-ethylbenzenephosphonic acid, phenylphosphinic acid, aminoquinones, silane coupling agents, titan coupling agents, fluorine-containing alkylsulfuric esters and alkali metal salts thereof. Examples of suitable lubricant include: solid lubricants such as molybdenum disulfide, tungsten disulfide, graphite, boron nitride and graphite fluoride; fatty acid lubricants such as monobasic fatty acids having 8 to 24 carbon atoms, either saturated or unsaturated and straight chain or branched; fatty acid ester lubricants such as mono-, di- or triesters of monobasic fatty acids having 10 to 24 carbon atoms, either saturated or unsaturated and straight-chain or branched, and one of mono- to hexahydric alcohols having 2 to 12 carbon atoms, either saturated or unsaturated and straight-chain or branched, and fatty acid esters of monoalkyl ethers of alkylene oxide polymers; and other lubricants such as silicone oils, polar group-containing silicones, fatty acid-modified silicones, fluorine-containing silicones, fluorine-containing alcohols, fluorine-containing esters, polyolefins, polyglycols, alkylphosphoric esters and alkali metal salts thereof, alkylsulfuric esters and alkali metal salts thereof, polyphenyl ethers, metal (e.g., Li, Na, K, or Cu) salts of fatty acid, mono- to hexahydric alcohols having 12 to 22 carbon atoms, either saturated or unsaturated and straight-chain or branched, alkoxyalcohols having 12 to 22 carbon atoms, either saturated or unsaturated and straight-chain or branched, fatty acid amides having 8 to 22 carbon atoms and aliphatic amines having 8 to 22 carbon atoms.

Examples of the fatty acid lubricants include capric acid, caprylic acid, lauric acid, myristic acid, palmitic acid, stearic acid, behenic acid, oleic acid, elaidic acid, linoleic acid, linolenic acid, and isostearic acid. Examples of the fatty acid ester lubricants include butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentyl glycol didecanoate, and ethylene glycol dioleate. Examples of the alcohol lubricants are oleyl alcohol, stearyl alcohol, and lauryl alcohol.

When use of a fatty acid ester compound as a lubricant is compared with use of a mixture of a fatty acid ester compound and a fatty acid, it is preferred to use only a fatty acid ester compound in order to adjust the dynamic friction coefficient to the recited level for the following reason. As previously stated, because the formation of an air film between a magnetic head and the magnetic recording medium of the invention is very stable, the function primarily required of the lubricant is only the protection of the surface of the magnetic recording medium. This being the case, addition of a fatty acid lubricant rather reduces the frictional coefficient at a low speed, which is considered to destabilize the air film.

The amount of the lubricant to be added is preferably 0.01% to 30% by mass, still preferably 0.05 to 10% by mass, based on the ferromagnetic powder.

Examples of useful surfactants include nonionic ones, such as alkylene oxide types, glycerol types, glycidol types, and alkylphenol ethylene oxide adducts; cationic ones, such as cyclic amines, ester amides, quaternary ammonium salts, hydantoin derivatives, heterocyclic compounds, phosphonium salts, and sulfonium salts; anionic ones containing an acidic group, such as a carboxyl group, a sulfonic acid group, a sulfuric ester group, or a phosphoric acid group; and amphoteric ones, such as amino acids, aminosulfonic acids, amino alcohol sulfuric or phosphoric esters, and alkyl betaines. For the details of these surfactants, refer to Kaimen Kasseizai Binran published by Sangyo Tosho K.K.

The abrasives for use in the invention are chosen from known abrasives mostly having a Mohs hardness of 6 or higher, either individually or mixed. Examples of useful abrasives include α-alumina having an α phase content of 90% or more, β-alumina, ultrafine diamond, silicon carbide, chromium oxide, cerium oxide, α-iron oxide, corundum, silicon nitride, silicon carbide, titanium carbide, titanium oxide, silicon dioxide, and boron nitride. These abrasives may be used as a composite form (an abrasive surface treated with another).

Existence of impurity compounds or elements, which are sometimes observed in the abrasives, will not affect the effect as long as the content of the main component is 90% by mass or higher. The abrasives preferably have an average particle size of 0.01 to 1 μm. It is desirable for the abrasive to have a narrow size distribution especially for the enhancement of the electromagnetic characteristics. In order to improve durability, abrasives different in particle size may be used in combination, or a single kind of an abrasive having a broadened size distribution may be used to produce the same effect.

The abrasive particles preferably have a tap density of 0.3 to 1.5 g/cc, a water content of 0.1% to 5% by mass, a pH of 2 to 11, and a specific surface area of 1 to 40 m²/g. The abrasive grains may be needle-like, spherical, or cubic. Angular grains are preferred for high abrasive performance.

Examples of commercially available abrasives which can be used in the invention are AKP-10, AKP-15, AKP-20, AKP-30, AKP-50, HIT-20, HIT-30, HIT-50, HIT-60A, HIT-50G, HIT-70, HIT-80, HIT-82, and HIT-100 (from Sumitomo Chemical Co., Ltd.); ERC-DBM, HP-DBM, and HPS-DBM (from Reynolds Metals Co.); WA10000 (from Fujimi Kenmazai K.K.); UB 20 (from Uyemura & CO., LTD); G-5, Chromex U2, and Chromex U1 (from Nippon Chemical Industrial Co., Ltd.); TF100 and TF140 (from Toda Kogyo Corp.); Beta-Random Ultrafine (from Ibiden Co., Ltd.); and B-3 (from Showa Mining Co., Ltd.).

The amount of the abrasive to be used in the magnetic layer may be, for example, 2 to 20 parts by mass per 100 parts by mass of the ferromagnetic powder. When added to a non-magnetic layer, the amount may be, for example, 2 to 20 parts by mass per 100 parts by mass of nonmagnetic powder.

The kinds and amounts of the dispersant, lubricant, surfactant, and other additives to be used in the magnetic layer and/or the nonmagnetic layer can be varied according to the intended purpose. The following is a few illustrative examples of strategies of the use of the additives. (1) A dispersing agent has a property of being adsorbed or bonded to solid particles via its polar groups. It is adsorbed or bonded via the polar groups mostly to the surface of ferromagnetic powder when used in a magnetic layer or the surface of nonmagnetic powder when used in a nonmagnetic layer. It is assumed that, after once being adsorbed to metal or metal compound particles, an organophosphorus compound, for instance, is hardly desorbed therefrom. As a result, the ferromagnetic powder or nonmagnetic powder treated with a dispersant appears to be covered with an alkyl group, an aromatic group or the like, which makes the particles more compatible with a binder resin component and more stable in their dispersed state. (2) Since lubricants are liable to bleed because they exist in a free state, their bleeding is controlled by using fatty acids differing in melting points between the magnetic layer and the nonmagnetic layer or by using esters different in boiling point or polarity between the magnetic layer and the nonmagnetic layer. (3) Coating stability is improved by adjusting the amount of the surfactant. (4) The amount of the lubricant in the nonmagnetic layer is increased to improve the lubricating effect.

The above-described dispersants, lubricants, and other additives do not always need to be pure and may contain impurities, such as isomers, unreacted materials, by-products, decomposition products, and oxides. The proportion of the impurities is preferably 30% by mass at the most, still preferably 10% by mass or less.

All or part of the additives can be added at any stage of preparing the magnetic or nonmagnetic coating composition for the formation of the magnetic or nonmagnetic layer. For example, the additives can be blended with the ferromagnetic powder before kneading, or be mixed with the ferromagnetic powder, a binder, and a solvent in the step of kneading, or be added during or after the step of dispersing or immediately before coating.

A coating composition for the magnetic layer may contain an organic solvent. Typical examples of the solvents include ketones, such as acetone, methyl ethyl ketone, methyl isobutyl ketone, diisobutyl ketone, cyclohexanone, isophorone, and tetrahydrofuran; alcohols, such as methanol, ethanol, propanol, butanol, isobutyl alcohol, isopropyl alcohol, and methylcyclohexanol; esters, such as methyl acetate, butyl acetate, isobutyl acetate, isopropyl acetate, ethyl lactate, and glycol acetate; glycol ethers, such as glycol dimethyl ether, glycol monoethyl ether, and dioxane; aromatic hydrocarbons, such as benzene, toluene, xylene, cresol, and chlorobenzene; chlorinated hydrocarbons, such as methylene chloride, ethylene chloride, carbon tetrachloride, chloroform, ethylenechlorohydrin, and dichlorobenzene; N,N-dimethylformamide; and hexane. They can be used either alone or as a mixture at any mixing ratio.

The organic solvent does not always need to be pure and may contain impurities, such as isomers, unreacted matter, by-products, decomposition products, oxidation products, and water. The impurity content is preferably 30% by mass or less, still preferably 10% by mass or less.

The organic solvent used in the formation of the magnetic layer and that used in the formation of the nonmagnetic layer are preferably the same in kind but may be different in amount. It is important that the arithmetic mean of the solvent composition for the upper magnetic layer be equal to or higher than that for the lower nonmagnetic layer. A solvent with somewhat high polarity is preferred for improving dispersing capabilities for powders. The solvent system preferably contains at least 50% of a solvent having a dielectric constant of 15 or higher. The solubility parameter of the solvent or the solvent system is preferably 8 to 11.

Where needed, the magnetic layer may contain carbon black. Useful carbon black species include furnace black for rubber, thermal black for rubber, carbon black for colors, and acetylene black.

The carbon black preferably has a specific surface area of 5 to 500 m²/g, a DBP absorption of 10 to 400 ml/100 g, an average particle size of 5 to 300 nm, a pH of 2 to 10, a water content of 0.1% to 10%, and a tap density of 0.1 to 1 g/ml.

Specific examples of commercially available carbon black products for use in the invention include Black Pearls 2000, 1300, 1000, 900, 905, 800, and 700, and Vulcan XC-72 from Cabot Corp.; #80, #60, #55, #50, and #35 from Asahi Carbon Co., Ltd.; #3050B, #3150B, #3250B, #3750B, #3950B, #2400B, #2300, #1000, #970B, #950, #900, #850B, #650B, #30, #40, #10B, and MA-600 from Mitsubishi Chemical Corp.; Conductex SC and RAVEN 8800, 8000, 7000, 5750, 5250, 3500, 2100, 2000, 1800, 1500, 1255, 1250, 150, 50, 40, 15, and RAVEN-MT-P from Columbian Carbon; and Ketjen Black EC from Akzo.

Carbon black having been surface treated with a dispersing agent, etc., resin-grafted carbon black, or carbon black with its surface partially graphitized may be used. Carbon black may previously been dispersed in a binder before being added to a coating composition for the magnetic layer. In selecting carbon black species for use in the magnetic layer, reference can be made, e.g., to Carbon Black Kyokai (ed.), Carbon Black Binran.

The above-recited carbon black species can be used either individually or as a combination thereof. The amount of carbon black if used is preferably 0.1% to 30% by mass based on the ferromagnetic powder. Carbon black serves for antistatic control, reduction of frictional coefficient, reduction of light transmission, film strength enhancement, and the like. These functions depend on the species. Accordingly, it is understandably possible, or rather desirable, to optimize the kinds, amounts, and combinations of the carbon black species for each layer according to the intended purpose with reference to the above-mentioned characteristics, such as particle size, DBP absorption, conductivity, pH, and so forth.

The thickness of the magnetic layer is optimized according to the saturation magnetization and the head gap of the head used and the recording signal band. It preferably ranges from 0.03 to 0.10 μm, still preferably 0.03 to 0.08 μm. The magnetic layer may have a single layer structure or a multilayer structure composed of two or more magnetic sublayers different in magnetic characteristics. Known technology with reference to such a multilayer magnetic layer structure can be applied.

### 3. Nonmagnetic Layer

The magnetic recording medium of the invention can have a nonmagnetic layer containing a nonmagnetic powder and a binder between the nonmagnetic support and the magnetic layer. The nonmagnetic powder may be either organic or inorganic. If desired, the nonmagnetic layer may contain carbon black in addition to the nonmagnetic powder. Types of the inorganic nonmagnetic materials include metals, metal oxides, metal carbonates, metal sulfates, metal nitrides, metal carbides, and metal sulfides.

Examples of the inorganic nonmagnetic materials include titanium oxides (e.g., titanium dioxide), cerium oxide, tin oxide, tungsten oxide, ZnO, ZrO₂, SiO₂, Cr₂O₃, α-alumina having an α-phase content of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide. They can be used either individually or in combination. Preferred among them are α-iron oxide and titanium oxide.

The shape of the nonmagnetic powder particles may be any of acicular, spherical, polygonal, and platy shapes. The crystallite size of the nonmagnetic powder is preferably 4 nm to 1 μm, still preferably 40 to 100 nm. Particles with the crystallite size ranging from 4 nm to 1 μm provide appropriate surface roughness while securing dispersibility. The nonmagnetic powder preferably has an average particle size of 5 nm to 2 μm, still preferably 10 to 200 nm. If desired, nonmagnetic powders different in average particle size may be used in combination, or a single kind of a nonmagnetic powder having a broadened size distribution may be used to produce the same effect.

The specific surface area of the nonmagnetic powder preferably ranges from 1 to 100 m²/g, still preferably 5 to 70 m²/g, even still preferably 10 to 65 m²/g. In the preferred specific surface area range, the nonmagnetic powder provides appropriate surface roughness and is dispersible in a desired amount of a binder. The DBP absorption of the powder is preferably 5 to 100 ml/100 g, still preferably 10 to 80 ml/100 g, even still preferably 20 to 60 ml/100 g. The specific gravity of the powder is preferably 1 to 12, still preferably 3 to 6. The tap density of the powder is preferably 0.05 to 2 g/ml, still preferably 0.2 to 1.5 g/ml. Having the tap density falling within that range, the powder is easy to handle with little dusting and tends to be less liable to stick to equipment. The nonmagnetic powder preferably has a pH of 2 to 11, still preferably between 6 and 9. With the pH ranging between 2 and 11, an increase in frictional coefficient of the magnetic recording medium experienced in a high temperature and high humidity condition or due to release of a fatty acid lubricant can be averted. The water content of the nonmagnetic powder is preferably 0.1% to 5% by mass, still preferably 0.2% to 3% by mass, even still preferably 0.3% to 1.5% by mass. Within the preferred water content range, the powder is easy to disperse, and the resulting coating composition has a stable viscosity. The ignition loss of the powder is preferably small, being not more than 20% by mass.

The inorganic nonmagnetic powder preferably has a Mohs hardness of 4 to 10 to secure durability. The nonmagnetic powder preferably has a stearic acid adsorption of 1 to 20 μmol/m², still preferably 2 to 15 μmol/m². The heat of wetting of the nonmagnetic powder with water at 25° C. is preferably 200 to 600 erg/m². Solvents in which the nonmagnetic powder releases the recited heat of wetting can be used. The number of water molecules on the nonmagnetic powder at 100° to 400° C. is suitably 1 to 10 per 100 Å. The isoelectric point of the nonmagnetic powder in water is preferably pH 3 to 9.

It is preferred that the nonmagnetic powder be surface treated to have a surface layer of Al₂O₃, SiO₂, TiO₂, ZrO₂, SnO₂, Sb₂O₃, or ZnO. Among them, preferred for dispersibility are Al₂O₃, SiO₂, TiO₂, and ZrO₂, with Al₂O₃, SiO₂, and ZrO₂ being still preferred. These surface treating substances may be used either individually or in combination. According to the purpose, a composite surface layer can be formed by co-precipitation or a method comprising first applying alumina to the nonmagnetic particles and then treating with silica or vice versa. The surface layer may be porous for some purposes, but a homogeneous and dense surface layer is usually preferred.

Specific examples of commercially available nonmagnetic powders that can be used in the nonmagnetic layer include Nanotite from Showa Denko K.K.; HIT-100 and ZA-G1 from Sumitomo Chemical Co., Ltd.; DPN-250, DPN-250BX, DPN-245, DPN-270BX, DPB-550BX, and DPN-550RX from Toda Kogyo Corp.; titanium oxide series TTO-51B, TTO-55A, TTO-55B, TTO-55C, TTO-55S, and TTO-55D, SN-100, MJ-7, and α-iron oxide series E270, E271, and E300 from Ishihara Sangyo Kaisha, Ltd.; STT-4D, STT-30D, STT-30, and STT-65C from Titan Kogyo K.K.; MT-100S, MT-100T, MT-150W, MT-500B, MT-600B, T-100F, and T-500HD from Tayca Corp.; FINEX-25, BF-1, BF-10, BF-20, and ST-M from Sakai Chemical Industry Co., Ltd.; DEFIC-Y and DEFIC-R from Dowa Mining Co., Ltd.; AS2BM and TiO₂P25 from Nippon Aerosil Co., Ltd.; 100A and 500A from Ube Industries, Ltd.; and Y-LOP from Titan Kogyo K.K. and calcined products thereof.

The nonmagnetic layer may contain organic powder according to the purpose. Useful organic powders include acrylic-styrene resin powders, benzoguanamine resin powders, melamine resin powders, and phthalocyanine pigments. Polyolefin resin powders, polyester resin powders, polyamide resin powders, polyimide resin powders, and polyethylene fluoride resin powders are also usable.

The binder for use in the nonmagnetic layer is selected from those described for use in the magnetic layer. The additives described with respect to the magnetic layer may also be used in the nonmagnetic layer.

The thickness of the nonmagnetic layer is usually 0.2 to 5.0 μm, preferably 0.3 to 3.0 μm, more preferably 1.0 to 2.5 μm.

### 4. Backcoat Layer

The magnetic recording medium of the invention can have a backcoat layer for prevention of static charge or correction of curling. The backcoat layer preferably contains highly electroconductive fine carbon black powder as a main filler. It is preferred to use two carbon black species different in average particle size, i.e., fine carbon black particles having an average particle size, e.g., of 10 to 30 nm and coarse carbon black particles having an average particle size, e.g., of 50 to 500 nm (preferably 60 to 400 nm), in combination.

In general, addition of fine carbon black particles results in low surface resistivity and low light transmission of the backcoat layer. In view of the fact that many magnetic recording systems utilize a transmission of a magnetic tape as an operational signal, addition of fine carbon black particles is specially effective for applications to this kind of systems. Besides, fine carbon black particles are generally excellent in lubricant holding capability and therefore contributory to reduction of the coefficient of friction where a lubricant is used in combination.

The backcoat layer may contain a binder. The binder for use in the backcoat layer may be selected from those described for use in the magnetic layer. The amount of the binder in the backcoat layer is preferably 10% to 80% by mass, more preferably 20% to 60% by mass, based on the main filler.

The backcoat layer may contain inorganic powder, for example, inorganic powder having an average particle size of 80 to 250 nm and a Mohs hardness of 5 to 9. The inorganic powder to be used in the backcoat layer may be selected from the nonmagnetic powders and abrasives for use in the nonmagnetic layer. In particular, α-iron oxide and α-alumina are preferably used. The amount of the inorganic powder to be used is preferably 1% to 30% by mass, more preferably 5% to 15% by mass, based on the main filler.

The coarse carbon black particles, on the other hand, function as a solid lubricant. Furthermore, the coarse particles form micro projections on the backcoat layer surface to reduce the contact area, which contributes to reduction of the frictional coefficient.

Examples of commercially available fine carbon black particles include RAVEN 2000B (average particle size (hereinafter the same): 18 nm) and RAVEN 1500B (17 nm), both available from Columbian Carbon; BP800 (17 nm) from Cabot Corp.); PRINNTEX 90 (14 nm), PRINTEX 95 (15 nm), PRINTEX 85 (16 nm), and PRINTEX 75 (17 nm), all from Degussa AG; and #3950 (16 nm) from Mitsubishi Chemical Corp. Coarse carbon black particles are chosen from carbon black for rubber and carbon black for colors. Examples of commercially available coarse carbon black particles include Thermal Black (270 nm) from Cancarb, Ltd.; and RAVEN MTP (275 nm) from Columbian Carbon.

In using two kinds of carbon black having different average particle sizes in the backcoat layer, the mass ratio of fine particles to coarse particles is preferably 98:2 to 75:25, still preferably 95:5 to 85:15.

In addition to the above components the backcoat layer may optionally contain a dispersant and a lubricant. Examples of useful dispersants include fatty acids with 12 to 18 carbon atoms (RCOOH: R is an alkyl or alkenyl group having 11 to 17 carbon atoms), such as caprylic acid, capric acid, lauric acid, myristic acid, palmitic acid, stearic acid, behenic acid, oleic acid, elaidic acid, linoleic acid, linolenic acid, and stearolic acid, metal soaps formed between the fatty acids described and an alkali metal or alkaline earth metal, fluorine-containing ester compounds of the fatty acids described, amides of the fatty acids described, polyalkylene oxide alkylphosphoric esters, lecithin, trialkyl polyolefinoxy quaternary ammonium salts (in which “alkyl” is a C1-C5 alkyl group; and “olefin” is ethylene, propylene, and so on), sulfuric esters, copper phthalocyanine, and precipitated barium sulfate. The dispersant may be added in an amount of 0.5 to 20 parts by mass per 100 parts by mass of the binder resin.

The thickness of the backcoat layer is usually 0.1 to 4 μm, preferably 0.3 to 2.0 μm.

### 5. Other Layers

An undercoat layer for adhesion enhancement may be provided between the support and the nonmagnetic layer or the magnetic layer. The undercoat layer usually has a thickness of 0.01 to 0.5 μm, preferably 0.02 to 0.5 μm.

The magnetic recording medium of the invention is produced by preparing a coating composition for a magnetic layer (hereinafter “magnetic coating composition”), applying the magnetic coating composition to a nonmagnetic support, and subjecting the coating layer to orientation in a magnetic field, polishing, smoothing, and irradiation with electron rays.

The magnetic coating composition is prepared by dispersing by kneading a ferromagnetic powder, a binder, and necessary additives (e.g., carbon black, an abrasive, an antistatic agent, and a lubricant) usually together with a solvent. The solvent used for kneading is selected from those previously enumerated.

Any manner of kneading commonly employed in the preparation of a magnetic coating composition may be used. The order of adding the components is decided as appropriate. Part of a component may be dispersed preliminarily to be added, or components separately dispersed preliminarily may be mixed up in a final stage. General kneading machines can be used, such as a two-roll mill, a three-roll mill, a ball mill, a sand grinder, an attritor, a high-speed impeller, a high-speed stone mill, a high-speed impact mill, a disper, a kneader, a high-speed mixer, a homogenizer, and an ultrasonic disperser. More details for dispersing by kneading that may be applied to the invention are described in T. C. Patton, Paint Flow and Pigment Dispersion, John Wiley & Sons (1964), Shinichi Tanaka, Kogyo Zairyo, vol. 25, p. 37 (1977), U.S. Pat. Nos. 2,581,414 and 2,855,515, JP 1-106338, and JP 1-79274.

The ferromagnetic powder may previously be treated with the above described dispersant, lubricant, surfactant, antistatic agent, and the like prior to the step of dispersing. In dispersing the ferromagnetic powder, the ferromagnetic powder may be surface treated with, for example, an oxide or hydroxide of Al, Si, or P, a silane coupling agent, or a titan coupling agent.

Coating equipment used to apply the magnetic coating composition to a support includes an air doctor (air knife) coater, a blade coater, a rod coater, an extrusion coater, a squeegee coater, an impregnation coater, a reverse roll coater, a transfer roll coater, a gravure coater, a kiss roll coater, a cast coater, a spray coater, and a spin coater. In the case of a multilayered magnetic structure, a plurality of magnetic coating compositions may be applied successively or simultaneously. For the details of coating techniques, reference can be made to Saishin Coating Gijyutsu, published by Sogo Gijyutsu Center, 1983.

The ferromagnetic powder in the applied magnetic coating composition may be oriented in a magnetic field in a known manner. In the case of tape media, the coated web is subjected to orientation treatment in its longitudinal direction using cobalt magnets or a solenoid. In the case of disk media, although sufficiently isotropic orientation could sometimes be obtained without orientation, it is preferred to use a known random orientation apparatus in which cobalt magnets are obliquely arranged in an alternate manner or an alternating magnetic field is applied with a solenoid. It is also possible to provide a disk with circumferentially isotropic magnetic characteristics by vertical orientation in a known manner, for example, by using facing magnets with their polarities opposite. Vertical orientation is particularly preferred for high density recording. Circumferential orientation may be achieved by spin coating.

After orientation in a magnetic field, the magnetic layer is preferably polished and smoothed. The dynamic friction coefficient of the magnetic layer side can be adjusted within the specific range by carrying out the polishing and the smoothing under appropriate conditions.

The step of polishing may be carried out by lapping, chemical treatment, or electropolishing, preferably by lapping. The lapping operation is usually conducted first by wet lapping using a lapping fluid, followed by dry lapping with no fluid.

Abrasive grains and lapping fluids used in the lapping are conventional. Silicon carbide grains are preferably used in wet lapping, and alumina grains are preferably used in dry lapping. The grain size of the abrasive used in wet lapping is preferably #200 to #1000 (mesh size No. according to JIS, hereinafter the same), more preferably #600 to #900. The grain size of the abrasive used in dry lapping is preferably #1000 to #2000, more preferably #1300 to 1700. Lubricants, such as fatty acid esters, are preferably used as a lapping fluid.

The lapping pressure preferably ranges from 100 to 200 kPa, more preferably 120 to 180 kPa, even more preferably 140 to 160 kPa, in wet lapping; and 20 to 100 kPa, more preferably 30 to 80 kPa, even more preferably 40 to 60 kpa, in dry lapping. The lapping speed preferably ranges from 10 to 25 m/min, more preferably 10 to 20 m/min, in wet lapping; and 5 to 20 m/min, more preferably 8 to 15 m/min, in dry lapping. The lapping temperature is preferably 15° to 30° C., more preferably 20° to 25° C.

The step of smoothing may be carried out by calendering, lapping, chemical treatment, or electrolysis. Calendering is preferred.

Suitable calender rolls include plastic rolls made of heat resistant resins, such as epoxy resin, polyimide, polyamide or polyamide-imide, and metal rolls. The temperature of the calender rolls preferably ranges from 60° to 110° C., more preferably 90° to 100° C. The calender roll linear pressure preferably ranges from 98 to 490 kN/m, more preferably 196 to 441 kN/m, even more preferably 250 to 350 kN/m. The calender speed is preferably 20 to 150 m/min, more preferably 30 to 100 m/min.

After the polishing and smoothing treatments, the magnetic layer may be irradiated with electron rays in a usual manner.

A nonmagnetic layer, a backcoat layer, or any other optional layer, if provided, is formed in a usual manner by preparing a coating composition, applying the coating composition, and drying.

The resulting coated web is cut to size by means of a slitter or a like cutting machine to make disk media or tape media.

The magnetic recording medium of the invention is suited to magnetic write/read system using an MR head. The recording medium of the invention achieves a high output while suppressing an increase in error rate when used in a magnetic write/read system in which magnetic signals written on a recording medium by a write head are read by an MR head.

### EXAMPLES

The present invention will now be illustrated in greater detail with reference to Examples, but it should be understood that the invention is not limited thereto. Unless otherwise noted, all the parts are by mass.

### Example 1

### (1) Preparation of Coating Compositions for Magnetic Layer and Backcoating Layer

The components of each of the formulations below were kneaded in an open kneader and dispersed in a sand mill. The resulting dispersion was filtered through a filter having a pore size of 0.5 μm to prepare a coating composition.

### Formulation for Magnetic Layer:

| | |
|---|---|
| Hexagonal ferrite powder (Ba/Fe/Co/Zn (barium | 100 parts |
| ferrite) = 1/9/0.5/1; Hc: 199 kA/m (2.5 kOe); average | |
| length: 20 nm; average aspect ratio: 4) | |
| Sulfonic acid group-containing polyurethane resin | 10 parts |
| (sulfonic acid group concentration: 500 eq/ton; average | |
| molecular weight: 90000) | |
| Radiation curing resin (tripropylene glycol acrylate) | 20 parts |
| Carbon black (average particle size: 20 nm) | 0.3 parts |
| Diamond powder (average particle size: 50 nm) | 0.5 parts |
| Cyclohexanone | 100 parts |
| Methyl ethyl ketone | 100 parts |
| Butyl stearate | 0.5 parts |
| Stearic acid | 1 part |

### Formulation for Backcoat Layer:

| | |
|---|---|
| Nonmagnetic inorganic powder (α-iron oxide; average | 80 parts |
| length: 0.15 μm; average aspect ratio: 7; S_{BET}: 52 m²/g) | |
| Carbon black (average particle size: 20 nm) | 20 parts |
| Carbon black (average particle size: 50 nm) | 3 parts |
| Vinyl chloride copolymer | 13 parts |
| Sulfonic acid group-containing polyurethane resin | 6 parts |
| (sulfonic acid group concentration: 200 eq/ton; average | |
| molecular weight: 100000) | |
| Phenylphosphonic acid | 3 parts |
| Cyclohexanone | 140 parts |
| Methyl ethyl ketone | 170 parts |

### (2) Making of Magnetic Tape

The coating composition for magnetic layer was applied to a 6.0 μm thick PEN web having an Ra of 0.5 nm on its magnetic layer side and of 1.0 nm on the opposite side to a dry thickness of 100 nm. While the coating layer was wet, the coated web was subjected to a magnetic orientation treatment using magnets having a magnetic force of 0.5 T. After drying, the coated web was lapped at 25° C. a few times until the thickness of the coating layer reduced to 50 nm, each lapping procedure consisting of wet lapping using a lapping fluid containing silicon carbide abrasive grains having a grain size of #800 and butyl stearate under a pressure of 150 kPa at a speed of 10 m/min, followed by dry lapping using alumina grains having a grain size of #1500 under a pressure of 50 kPa at a speed of 10 m/min. The lapped web was calendered on a 5-roll calender having only metal rolls at a temperature of 100° C. under a linear pressure of 294 kN/m (300 kg/cm) at a speed of 100 m/min. The coating layer was then cured by irradiating with an electron beam at an accelerating voltage of 150 kV to a total dose of 0.5 Mrad. The coating composition for backcoat layer was applied to the opposite side of the web to a dry thickness of 0.5 μm. The coated web was slit to half inch (1.27 cm) width to give a magnetic tape of Example 1.

### Examples 2 to 4

Magnetic tapes were made in the same manner as in Example 1, except for changing the speed of wet lapping to 15 m/min, 20 m/min, and 25 m/min.

### Examples 5 and 6

Magnetic tapes were made in the same manner as in Example 3, except for changing the speed of calendering to 70 m/min and 50 m/min.

### Example 7

A magnetic tape was made in the same manner as in Example 3, except for changing the dry lapping speed to 8 m/min and changing the calender roll temperature and speed to 110° C. and 30 m/min, respectively.

### Example 8

A magnetic tape was made in the same manner as in Example 3, except for omitting stearic acid (1 part) from the formulation for magnetic layer.

### Example 9

A magnetic tape was made in the same manner as in Example 5, except for omitting stearic acid (1 part) from the formulation for magnetic layer.

### Comparative Example 1

A magnetic tape was prepared in the same manner as in Example 1, except that the magnetic coating composition was applied to a dry thickness of 50 nm and that the polishing by wet lapping was omitted.

### Comparative Example 2

A magnetic tape was prepared in the same manner as in Example 1, except for changing the wet lapping speed to 40 m/min.

### Comparative Example 3

A magnetic tape was made in the same manner as in Example 4, except for changing the calendering speed to 70 m/min and omitting the stearic acid (1 part) from the formulation for magnetic layer.

### Comparative Example 4

A magnetic tape was made in the same manner as in Example 4, except for changing the calendering speed to 70 m/min.

### Comparative Example 5

A magnetic tape was made in the same manner as in Comparative Example 1, except for omitting stearic acid (1 part) from the formulation for magnetic layer.

### Evaluation

The magnetic tapes prepared in Examples and Comparative Examples were evaluated as follows. All the measurements were taken at 23° C. and 50% RH. The results obtained are shown in Table 1.

### (1) Surface Roughness

The Ra of the magnetic layer was measured by AFM using Nanoscope 3 (from Digital Instruments) equipped with a silicon nitrile cantilever having a square pyramidal tip (tip angle: 70°) with a scan size of 30 μm.

### (2) Dynamic Friction Coefficient

A tape sample was put over a horizontally held AlTiC rod (diameter: 2 mm; Ra: 2.0±1.0 nm) with a wrap angle of 90°. A weight of 100 g was attached to the hanging end of the tape to give a tension of 100 gf (0.98 N). The force (gf) of pulling the other end of the tape horizontally at a velocity varied from 0.01 m/s to 2 m/s was measured with a tensiometer, from which a dynamic friction coefficient (μk) was calculated using the Euler's equation: μk=(2/π)×ln(T1/100) (where T1 is the force (gf) measured with the tensiometer). To simulate the friction between a magnetic head and a magnetic tape, the AlTiC rod was made of the same material as, and designed to have surface properties close to those of, an AlTiC slider, the main sliding member of a magnetic head. The upper measurement limit in this test was 0.9. When the pulling force was unmeasurable due to stickage or tendency to stickage of a sample tape to the rod, the friction coefficient was taken as “≧9” as long as the magnetic layer was not broken.

### (3) Electromagnetic Characteristics

A tape sample was wound on an LTO reel and tested for writing and reading on a reel-to-reel tester equipped with an LTO head. The tape speed was 5 m/s. The position of the magnetic head at the time of measurement was such that a stationary tape was in contact with the head at a wrap angle of 4°. While the tape stood still, the head was retracted away from the tape, and the tape was driven with the head remaining retracted. After the tape running speed became steady, the head was moved to the tape to the set position (wrap angle of 4°), and the electromagnetic characteristics were determined.

Reproduction output of signals recorded at 250 kfci (=9.84 kfcmm) was measured using a spectrum analyzer. When the output level was at least 3 dB higher than that of a reference tape having a bit error rate of 1×10⁻⁵ that works out the system at a linear recording density of 250 kfci, the sample was determined to have sufficiently satisfactory electromagnetic characteristics.

The output signals were measured with a digital oscilloscope. The amplitude (peak-to-valley) of 1000 output signals were acquired and statistically processed to obtain an amplitude distribution in terms of standard deviation/mean×100 (%). To avoid error due to amplitude fluctuation, an amplitude distribution within 5% of that required in high density recording of 250 kfci or higher as calculated from the statistical distribution was regarded sufficiently satisfactory.

### (4) Tape Wind Quality

A tape sample was wounded on an LTO reel, and the tape pack was driven on a reel-to-reel tester once forward and once backward. When the number of popped strands of the resulting tape pack was within 5, which is regarded acceptable for the system design, the sample was determined to have good wind quality.

### (5) Lateral Tape Motion (LTM)

A tape sample was driven on a reel-to-reel tester, and LTM was measured with a displacement sensor. A sample having an LTM within 2 μm, which is regarded acceptable for the system design, was determined to be sufficiently satisfactory. Similarly to the measurement of electromagnetic characteristics, it was not until the tape speed became steady that the magnetic head was moved to the tape to have a wrap angle of 4°. The tape speed was 5 m/s.

TABLE 1-1

| | | | Example No. | | | | | | | | |
|---|---|---|---|---|---|---|---|---|---|---|---|
| | | | 1 | 2 | 3 | 4 | 5 | 6 | 7 | 8 | 9 |
| Ra (nm) | | | 1.3 | 1.3 | 1.3 | 1.3 | 1.0 | 0.8 | 0.2 | 1.3 | 1.0 |
| Dynamic | 2 | m/s | 0.40 | 0.37 | 0.35 | 0.35 | 0.35 | 0.35 | 0.45 | 0.30 | 0.35 |
| Friction | 1 | m/s | 0.80 | 0.70 | 0.60 | 0.50 | 0.60 | 0.65 | 0.90 | 0.70 | 0.70 |
| Coefficient | 0.5 | m/s | ≧0.9 | 0.80 | 0.60 | 0.60 | 0.60 | 0.65 | ≧0.9 | 0.80 | 0.80 |
| | 0.1 | m/s | ≧0.9 | ≧0.9 | 0.70 | 0.60 | 0.70 | 0.70 | ≧0.9 | 0.90 | ≧0.9 |
| | 0.01 | m/s | ≧0.9 | ≧0.9 | 0.85 | 0.80 | 0.90 | ≧0.9 | ≧0.9 | ≧0.9 | ≧0.9 |

| Number of Popped Strands | | 0 | 0 | 2 | 4 | 1 | 1 | 0 | 0 | 0 |
|---|---|---|---|---|---|---|---|---|---|---|
| LTM (μm) | | 0.5 | 0.8 | 1.5 | 2.0 | 1.3 | 1.1 | 0.3 | 0.8 | 0.3 |
| Electromagnetic | 250 kfci | 4.7 | 4.5 | 4.0 | 3.2 | 4.2 | 4.5 | 6.0 | 4.5 | 5.1 |
| Characteristics | Output (dB) | | | | | | | | | |
| | Amplitude | 3.0 | 3.7 | 4.2 | 5.0 | 3.9 | 3.7 | 1.5 | 3.5 | 2.5 |
| | Distribution | | | | | | | | | |

TABLE 1-2

| | | | Comparative Example No. | | | | |
|---|---|---|---|---|---|---|---|
| | | | 1 | 2 | 3 | 4 | 5 |
| Ra (nm) | | | 1.3 | 1.3 | 1.0 | 1.0 | 1.3 |
| Dynamic | 2 | m/s | 0.25 | 0.35 | 0.32 | 0.30 | 0.30 |
| Friction | 1 | m/s | 0.28 | 0.43 | 0.38 | 0.30 | 0.35 |
| Coefficient | 0.5 | m/s | 0.35 | 0.50 | 0.45 | 0.35 | 0.40 |
| | 0.1 | m/s | 0.40 | 0.55 | 0.48 | 0.40 | 0.45 |
| | 0.01 | m/s | 0.54 | 0.65 | 0.61 | 0.45 | 0.55 |

| Number of Popped Strands | | 25 | 14 | 15 | 22 | 20 |
|---|---|---|---|---|---|---|
| LTM (μm) | | 6.0 | 3.2 | 3.5 | 4.5 | 4.0 |
| Electromag- | 250 kfci | 1.5 | 2.5 | 2.0 | 1.6 | 1.7 |
| netic | Output (dB) | | | | | |
| Character- | Amplitude | 12.0 | 10.0 | 8.0 | 12.0 | 10.0 |
| istics | Distribution | | | | | |

The results in Tables 1 prove that magnetic tapes having a dynamic friction coefficient of 0.5 or more at a speed of 1 m/s are good in all respects, i.e., tape wind quality, LTM, and electromagnetic characteristics. It is also seen that the effects are enhanced as the dynamic friction coefficient increases.

Comparison between Example 3 and Examples 5, 6, and 7 proves that the improving effects on tape wind quality, LTM, and electromagnetic characteristics are further ensured when the Ra is 0.2 to 1.0 nm and that the smaller the Ra, the higher the effects. However, even with an Ra of 1.0 nm or less, the effects on tape wind quality, LTM, and electromagnetic characteristics are limited when the dynamic friction coefficient is smaller than 0.5 as in Comparative Examples 3 and 4.

Comparison between Examples 3 and 8 and comparison between Examples 5 and 9 reveal that the dynamic friction coefficient increases when only an aliphatic ester is used as a lubricant (an aliphatic acid is not used), thereby ensuring the improvements on tape wind quality, LTM, and electromagnetic characteristics. However, the effect of using only an aliphatic ester lubricant is lessened when the dynamic friction coefficient is less than 0.5 as in Comparative Examples 3 and 5.

On comparing Examples 3, 5, and 9, it is seen that the improving effects of having a dynamic friction coefficient of 0.5 or more on tape wind quality, LTM, and electromagnetic characteristics are ensured by additionally having an Ra of 1.0 nm or less, and the effects are further ensured by using only an aliphatic ester as a lubricant.

What is claimed is:

1. A magnetic recording medium comprising a nonmagnetic support and a magnetic layer, wherein the magnetic recording medium has a coefficient of dynamic friction, on a magnetic layer side surface, of 0.5 or larger as measured at a speed of 1 m/s relative to a sliding member of a magnetic head.

2. The recording medium according to claim 1, wherein the magnetic layer side surface has an arithmetic average roughness Ra of from 0.2 to 1.0 nm.

3. The recording medium according to claim 1, wherein the magnetic layer is free of a fatty acid as a lubricant.

4. The recording medium according to claim 2, wherein the magnetic layer is free of a fatty acid as a lubricant.

5. The recording medium according to claim 1, wherein the magnetic layer comprises a fatty acid ester as a sole lubricant.

6. The recording medium according to claim 2, wherein the magnetic layer comprises a fatty acid ester as a sole lubricant.

7. The recording medium according to claim 1, which is a magnetic tape.

8. The recording medium according to claim 2, which is a magnetic tape.

9. The recording medium according to claim 1, wherein the coefficient of dynamic friction is from 0.5 to 0.9.

10. The recording medium according to claim 1, wherein the coefficient of dynamic friction is from 0.6 to 0.8.

11. A method of producing the magnetic recording medium according to claim 1, comprising: applying a coating composition for a magnetic layer to a nonmagnetic support to form a magnetic layer and subjecting the magnetic layer to polishing and smoothing.

12. The method according to claim 11, wherein the polishing is lapping.
